(19) United States
(12) Patent Application Publication
(10) Pub. No.: US 2025/0382197 A1
(43) Pub. Date: Dec. 18, 2025

(54) POSITIVE-ELECTRODE ACTIVE MATERIAL FOR SECONDARY BATTERIES, METHOD FOR MANUFACTURING SAME, POSITIVE ELECTRODE FOR SECONDARY BATTERIES USING SAME, AND SECONDARY BATTERY

(71) Applicant: NICHIA CORPORATION, Anan-shi (JP)

(72) Inventors: Yoshitomo MIYASHITA, Tokushima-shi (JP); Kenta KAWAI, Tokushima-shi (JP); Yasuhiro YOSHIDA, Naka-gun (JP); Masahiro MURAYAMA, Tokushima-shi (JP); Kazuya ISHIKAWA, Anan-shi (JP); Jota MORIMOTO, Tokushima-shi (JP)

(73) Assignee: NICHIA CORPORATION, Anan-shi (JP)

(21) Appl. No.: 18/877,251

(22) PCT Filed: Jun. 26, 2023
(86) PCT No.: PCT/JP2023/023568

§ 371 Date: Dec. 19, 2024

(30) Foreign Application Priority Data
Jun. 30, 2022 (JP) 2022-105831
Aug. 1, 2022 (JP) 2022-122790
Jun. 14, 2023 (JP) 2023-097504

(51) Int. Cl. C01G 53/504; H01M 10/0525

(52) U.S. Cl. CPC C01G 53/504; H01M 10/0525; C01P 2002/85; C01P 2004/02; C01P 2004/51; C01P 2006/40

(57) ABSTRACT

Provided is a method for producing a cathode active material for a secondary battery which enables configuring a battery with improved battery resistance. The method includes providing a lithium transition metal composite powder in which a ratio of the number of moles of nickel atoms to the total number of moles of metal atoms other than lithium is 0.5 or more and less than 1 and a ratio of the number of moles of cobalt atoms to the total number of moles of metal atoms other than lithium is 0 or more and less than 0.5, the lithium transition metal composite powder having a layered structure; contacting the lithium transition metal composite powder with a cobalt raw material to obtain a cobalt-adhered composite oxide; subjecting the cobalt-adhered composite oxide to a first heat treatment performed at a temperature higher than 600° C. and lower than 800° C. to obtain a first heat-treated product; contacting the first heat-treated product with a niobium raw material to obtain a niobium-adhered composite oxide; and subjecting the niobium-adhered composite oxide to a second heat treatment performed at a temperature higher than 300° C. and lower than 500° C. to obtain a second heat-treated product.

### TECHNICAL FIELD

The present disclosure relates to a cathode active material for a secondary battery, a method for producing the same, and a positive electrode for a secondary battery and a secondary battery using the same.

### BACKGROUND ART

Lithium-ion batteries are secondary batteries with good energy density and cycle characteristics. Recently, all-solid-state batteries have been developed that use solids instead of conventional organic solvents as electrolytes, and it is expected that they will achieve higher safety than conventional batteries. In particular, sulfide-based solid electrolytes, which contain sulfur in the solid electrolytes, have achieved high electrical conductivity. On the other hand, sulfide-based solid electrolytes involve issues such as side reactions between the cathode layer and the sulfide-based solid electrolyte, and the formation of a high-resistance layer at the interface between the cathode active material and the solid electrolyte.

JP2018-125214A discloses a technique for coating the surface of a cathode active material with lithium niobate to inhibit the formation of a high resistance layer at the contact interface between a sulfide solid electrolyte and the cathode active material, and further to prevent side reactions between the sulfide solid electrolyte and the cathode active material.

### SUMMARY OF INVENTION

### Problem to be Solved by the Invention

However, in the case of a lithium transition metal composite oxide having a high nickel content, even if the surface is coated with a niobium compound such as lithium niobate, there is still a problem that the battery resistance is high, and further improvement in output characteristics is required. One aspect of the present invention aims at providing a cathode active material for a secondary battery that allows for reducing battery resistance, a method for producing the same, and a positive electrode for a secondary battery and a secondary battery using the same.

### Means for Solving the Problem

A first aspect is a method for producing a cathode active material for a secondary battery, the method including: providing a lithium transition metal composite powder in which a ratio of the number of moles of nickel atoms to the total number of moles of metal atoms other than lithium is 0.5 or more and less than 1 and a ratio of the number of moles of cobalt atoms to the total number of moles of metal atoms other than lithium is 0 or more and less than 0.5, the lithium transition metal composite powder having a layered structure; contacting the lithium transition metal composite powder with a cobalt raw material to obtain a cobalt-adhered composite oxide; subjecting the cobalt-adhered composite oxide to a first heat treatment performed at a temperature higher than 600° C. and lower than 800° C. to obtain a first heat-treated product; contacting the first heat-treated product with a niobium raw material to obtain a niobium-adhered composite oxide; and subjecting the niobium-adhered composite oxide to a second heat treatment performed at a temperature higher than 300° C. and lower than 500° C. to obtain a second heat-treated product.

A second aspect is a cathode active material for a secondary battery, including: a lithium transition metal composite oxide having a layered structure and having a composition in which the ratio of the number of moles of nickel atoms to the total number of moles of metal atoms other than lithium is 0.5 or more and less than 1 and in which the ratio of the number of moles of cobalt atoms to the total number of moles of metal atoms other than lithium is 0.01 or more and less than 0.5, the lithium transition metal composite oxide having a secondary particle surface containing a niobium compound on at least a part of the particle surface, the lithium transition metal composite oxide having a higher cobalt concentration in a second region than in a first region, where the first region is a region that is approximately 60 nm deep from the secondary particle surface, and the second region is a region that is approximately 10 nm deep from the secondary particle surface.

A third aspect is a positive electrode for a secondary battery including a cathode active material layer containing the cathode active material for a secondary battery of the second aspect. A fourth aspect is a secondary battery including the positive electrode for a secondary battery of the third aspect, a negative electrode, and an electrolyte.

### Effect of the Invention

According to an aspect of the present disclosure, it is possible to provide a cathode active material for a secondary battery that reduces battery resistance, a method for producing the same, and a positive electrode for a secondary battery and a secondary battery using the same.

### BRIEF DESCRIPTION OF DRAWINGS

FIG. 1 shows an example of a SEM image of a cathode active material of Example 1.

FIG. 2 shows an example of a SEM-EDX line analysis result of the cathode active material of Example 1.

### DESCRIPTION OF EMBODIMENTS

In the case where a plurality of substances corresponding to each component are present in a composition, the content of each component in the composition herein means the total amount of the plurality of substances present in the composition, unless otherwise specified. An embodiment of the present disclosure will now be described in detail. However, the embodiment described below merely exemplifies a cathode active material for secondary batteries and a producing method thereof for embodying the technical idea of the present disclosure, and therefore the present disclosure is not limited to the cathode active material for secondary batteries and the producing method thereof described below.

### Method for Producing Cathode Active Material for Secondary Battery

A method for producing a cathode active material for a secondary battery (hereinafter also referred to simply as “cathode active material”) includes: a provision step of providing a lithium transition metal composite powder in which a ratio of the number of moles of nickel to the total number of moles of metals other than lithium is 0.5 or more and less than 1 and a ratio of the number of moles of cobalt to the total number of moles of metals other than lithium is 0 or more and less than 0.5, the lithium transition metal composite powder having a layered structure; a first adhesion step of bringing the lithium transition metal composite powder into contact with a cobalt raw material to obtain a cobalt-adhered composite oxide; a first heat treatment step of subjecting the cobalt-adhered composite oxide to a first heat treatment performed at a temperature higher than 600° C. and lower than 800° C. to obtain a first heat-treated product; a second adhesion step of bringing the first heat-treated product into contact with a niobium raw material to obtain a niobium-adhered composite oxide; and a second heat treatment step of subjecting the niobium-adhered composite oxide to a second heat treatment performed at a temperature higher than 300° C. and lower than 500° C. to obtain a second heat-treated product. In the cathode active material obtained by this producing method, the cobalt concentration near the secondary particle surface of the lithium transition metal composite powder having a high nickel ratio is increased, thereby improving the lithium-ion conductivity in the cathode active material. Furthermore, a coating portion of a niobium compound is provided on the secondary particle surface of the cathode active material, which inhibits the formation of a high resistance layer between the solid electrolyte and the cathode. Thus, it is thought that an all-solid-state secondary battery containing this can achieve high output characteristics.

### Provision Step

In the provision step, a lithium transition metal composite powder having a layered structure is provided, which has a composition where the ratio of the number of moles of nickel to the total number of moles of metals other than lithium is 0.5 or more and less than 1 and where the ratio of the number of moles of cobalt is 0 or more and less than 0.5.

The lithium transition metal composite powder contains at least lithium and nickel and may further contain at least one metal element selected from the group consisting of cobalt, manganese, and aluminum. The lithium transition metal composite powder may be provided by purchasing or by manufacturing a lithium transition metal composite powder having a desired composition and structure.

The ratio of the number of moles of nickel to the total number of moles of metals other than lithium in the composition of the lithium transition metal composite powder provided in the provision step may be 0.5 or more and less than 1. The ratio of the number of moles of nickel to the total number of moles of metals other than lithium may be preferably 0.6 or more, more preferably 0.7 or more. The ratio of the number of moles of nickel to the total number of moles of metals other than lithium may be preferably 0.95 or less, more preferably 0.92 or less, and particularly preferably 0.9 or less. When the mole ratio of nickel is in the above range, the effect of improving the output characteristics of a secondary battery using the obtained cathode active material tends to be more pronounced.

The ratio of the number of moles of cobalt to the total number of moles of metals other than lithium in the composition of the lithium transition metal composite powder provided in the provision step may be 0 or more. From the viewpoint of output characteristics, the ratio of the number of moles of cobalt to the total number of moles of metals other than lithium in the lithium transition metal composite powder may be preferably 0.01 or more, or 0.02 or more, and more preferably 0.03 or more. In addition, the ratio of the number of moles of cobalt to the total number of moles of metals other than lithium in the lithium transition metal composite powder may be, for example, 0.5 or less, and from the viewpoint of charge/discharge capacity, it may be preferably 0.3 or less, more preferably 0.2 or less, and even more preferably 0.12 or less, or 0.09 or less. The above range can further improve the output characteristics while reducing costs.

The lithium transition metal composite powder provided in the provision step may further contain in its composition a metal element M¹ including at least one selected from the group consisting of manganese and aluminum. When the lithium transition metal composite powder includes the metal element M¹, the ratio of the number of moles of M¹ to the total number of moles of metals other than lithium may be, for example, greater than 0, and from the viewpoint of safety, may be preferably 0.03 or more, more preferably 0.05 or more, or 0.07 or more. The ratio of the number of moles of M¹ to the total number of moles of metals other than lithium may be, for example, 0.5 or less, and from the viewpoint of charge/discharge capacity, may be preferably 0.4 or less, more preferably 0.3 or less, or 0.25 or less.

The lithium transition metal composite powder provided in the provision step may further contain in its composition a metal element M² including at least one selected from the group consisting of boron, sodium, magnesium, silicon, phosphorus, sulfur, potassium, calcium, titanium, vanadium, chromium, zinc, strontium, yttrium, zirconium, niobium, molybdenum, indium, tin, barium, lanthanum, cerium, neodymium, samarium, europium, gadolinium, tantalum, tungsten, and bismuth. When the lithium transition metal composite powder includes the metal element M², the ratio of the number of moles of M² to the total number of moles of metals other than lithium may be, for example, greater than 0, preferably 0.0005 or more, particularly preferably 0.001 or more, or 0.002 or more. The ratio of the number of moles of M² to the total number of moles of metals other than lithium may be, for example, 0.1 or less, preferably 0.05 or less, and particularly preferably 0.02 or less, 0.01 or less, or 0.006 or less.

The ratio of the number of moles of lithium to the total number of moles of metals other than lithium in the composition of the lithium transition metal composite powder provided in the provision step may be, for example, 0.95 or more, preferably 0.98 or more, or 1 or more. The ratio of the number of moles of lithium to the total number of moles of metals other than lithium may be, for example, 1.5 or less, preferably 1.3 or less, or 1.1 or less.

The composition of the lithium transition metal composite powder provided in the provision step may be, for example, a composition represented by Formula (1) below.

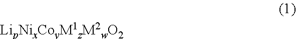

In Formula (1), 0.95≤p≤1.5, 0.5≤x<1, 0≤y<0.5, 0≤z<0.5, 0≤w≤ 0.1, 0.8≤x+y+z+w≤1.2, M¹ includes at least one selected from the group consisting of Al and Mn, and M² includes at least one selected from the group consisting of B, Na, Mg, Si, P, S, K, Ca, Ti, V, Cr, Zn, Sr, Y, Zr, Nb, Mo, In, Sn, Ba, La, Ce, Nd, Sm, Eu, Gd, Ta, W, and Bi.

In Formula (1), p may be 0.98≤p, 0.1≤p, p≤1.3, or p≤1.1. x may be 0.6≤x, 0.7≤x, x≤0.95, x≤0.92, or x≤0.9. y may be 0.01≤y, 0.03≤y, y≤0.3, y≤ 0.2, or y≤0.12. z may be 0.03≤z, 0.05≤z, z≤0.5, z≤0.4, or z≤0.3. w may be 0<w, 0.0005≤w, 0.001≤w, w≤0.05, or w≤0.02. x+y+z+w may be 0.9≤x+y+z+w≤1.

The lithium transition metal composite powder provided in the provision step may be composed of secondary particles each formed by aggregation of more than 20 primary particles, but is preferably in the form of particles consisting of secondary particles each composed of 20 or less, preferably 10 or less primary particles, or in the form of single particles, i.e., so-called single particles. D₅₀/D_{SEM}, which is a ratio of the 50% particle diameter D₅₀ in the cumulative particle size distribution on a volume basis to the average particle diameter D_{SEM} based on observation with a scanning electron microscope (SEM), of the lithium transition metal composite powder in the single particle form is 1 or more and 4 or less.

In the lithium transition metal composite powder provided in the provision step, it is indicated that the closer D₅₀/D_{SEM} is to 1, the smaller the number of primary particles constituting the secondary particles contained in the lithium transition metal composite powder is, and that when D₅₀/D_{SEM} is 1, the secondary particles are composed almost entirely of single particles. From the viewpoint of durability, D₅₀/D_{SEM} is preferably 1 to 4, and from the viewpoint of output density, D₅₀/D_{SEM} is preferably 3.5 or less, more preferably 3 or less, even more preferably 2.5 or less, and particularly preferably 2 or less, or 1.5 or less. It can be expected that the closer D₅₀/D_{SEM} is to 1, the more greater the effect of improving the output characteristics when the second region has a higher cobalt concentration than the first region. In this specification, whether D₅₀/D_{SEM} is a value different from 1 or is 1, independently existing particles are regarded as secondary particles.

In the lithium transition metal composite powder provided in the provision step, the average particle diameter D_{SEM} based on electron microscope observation may be, for example, 0.1 μm or more, and from the viewpoint of durability, it is preferably 0.3 μm or more, and more preferably 0.5 μm or more, or 1 μm or more. The average particle diameter D SEM based on electron microscope observation may be, for example, 20 μm or less, and from the viewpoint of power density and packing performance in an electrode plate, it is more preferably 10 μm or less, even more preferably 8 μm or less, and particularly preferably 5 μm or less, 4 μm or less, or 3 μm or less.

The average particle diameter D_{SEM} based on the observation by an electron microscope is the average value of the spherical equivalent diameters of the primary particles measured from a scanning electron microscope (SEM) image. Specifically, the average particle diameter D_{SEM} can be calculated as follows.
<1> Using a scanning electron microscope, set the magnification so that the number of secondary particles having a visible particle contour is 10 to 20. In this case, secondary particles having a particle diameter less than half of D₁₀ are not included in the number.
<2> For all secondary particles observed at the above magnification and having a visible contour and a particle diameter of at least half of D₁₀, the contours of the primary particles constituting each secondary particle are traced using an image processing software to determine the contour length of each primary particle. The spherical equivalent diameter is calculated from the contour length.
<3> The above processes <1> and <2> are repeated until the number of primary particles whose spherical equivalent diameters have been calculated exceeds 100.
The average particle diameter D_{SEM} is calculated as the arithmetic average value of the spherical equivalent diameters of the primary particles obtained by repeating the processes <1> and <2>.

The 50% particle diameter D₅₀ of the lithium transition metal composite powder provided in the provision step may be, for example, 1 μm or more and 30 μm or less. From the viewpoint of handleability, it is preferably 1.5 μm or more, and more preferably 2.5 μm or more. From the viewpoint of output density, it is preferably 10 μm or less, and more preferably 7 μm or less.

The 50% particle diameter D₅₀ is determined as the particle diameter corresponding to the cumulative 50% from the small diameter side in the cumulative particle size distribution on a volume basis measured under wet conditions using a laser diffraction particle size distribution analyzer. Similarly, the 90% particle diameter D₉₀ and the 10% particle diameter D₁₀ described later are determined as the particle diameters corresponding to the cumulative 90% and the cumulative 10%, respectively, from the small diameter side.

The ratio of the 90% particle diameter D₉₀ to the 10% particle diameter D₁₀ in the cumulative particle size distribution based on volume of the lithium transition metal composite powder provided in the provision step indicates the spread of the particle size distribution, where the smaller the value, the more uniform the particle diameter of the particles. D₉₀/D₁₀ may be, for example, 4 or less, and from the viewpoint of output density, it is preferably 3 or less, and more preferably 2.5 or less. D₉₀/D₁₀ may be, for example, 1.2 or more. The smaller the value of D₉₀/D₁₀, the more uniform the particle diameter, which is expected to result in more uniform coating with the niobium compound.

For the lithium transition metal composite powder with D₅₀/D_{SEM} of 1 or more and 4 or less provided in the provision step, for example, JP2017-188443A (U.S. Patent Publication No. 2017-0288221), JP2017-188444A (U.S. Patent Publication No. 2017-0288222), JP 2017-188445A (U.S. Patent Publication No. 2017-0288223), etc., can be referenced.

The lithium transition metal composite powder provided in the provision step contains nickel in its composition. From the viewpoint of the initial efficiency of the all-solid-state secondary battery, the lithium transition metal composite oxide preferably has a nickel element disorder determined by the X-ray diffraction method of 6% or less, 5% or less, 4.0% or less, and more preferably 2.0% or less. Here, the disorder of the nickel element means a chemical disorder of the transition metal ion (nickel ion) that should occupy the original site. In the lithium transition metal composite oxide having a layered structure, a typical one of the disorder is an interchange between alkali metal ions that should occupy the site represented by 3b in the Wyckoff symbol (3b site, hereafter the same) and transition metal ions that should occupy the 3a site.

The smaller the disorder of the nickel element, the more the initial efficiency tends to improve, which is preferable.

The disorder of nickel element in the lithium transition metal transition metal composite oxide can be determined by the X-ray diffraction method. The X-ray diffraction spectrum of the lithium transition metal transition metal composite oxide is measured by CuKα radiation. The composition model is (Li_{1-d}Ni_{d})(NiₓCo_{y}Mn_{z})O₂ (x+y+z=1), and the structure is optimized by Rietveld analysis, based on the obtained X-ray diffraction spectrum. The percentage of d calculated as a result of the structure optimization is the value of the disorder of nickel element.

Specifically, the lithium transition metal composite powder provided in the provision step can be prepared as follows. The method of preparing the lithium transition metal composite powder may include, for example, a precursor provision step of providing a precursor, and a synthesis step of synthesizing a lithium transition metal composite oxide from the precursor and a lithium compound.

In the precursor provision step, a precursor containing a composite oxide containing nickel (hereinafter, simply referred to as composite oxide) is provided. The precursor may be provided by purchasing, or may be provided by preparing a composite oxide having a desired composition by a conventional method. Examples of a method for obtaining a composite oxide having a desired composition include: a method in which raw material compounds (hydroxides, carbonic acid compounds, etc.) are mixed according to a target composition and decomposed into a composite oxide by heat treatment; and a coprecipitation method in which: a raw material compound soluble in a solvent is dissolved in a solvent; a precipitate having a target composition is obtained by adjusting the temperature, adjusting the pH, adding a complexing agent, etc.; and the precipitate is heat-treated to obtain a composite oxide. An example of a method for producing a composite oxide will be described below.

The method for obtaining a composite oxide by coprecipitation may include: a seed generation step of adjusting the pH, etc., of a mixed solution containing metal ions in a desired composition ratio to obtain seed crystals; a crystallization step of growing the generated seed crystals to obtain a composite hydroxide having desired properties; and a step of heat treating the obtained composite hydroxide to obtain a composite oxide. For details of such a method for obtaining a composite oxide, reference may be made to, for example, JP2003-292322A and JP2011-116580A (US Patent Publication 2012-0270107).

In the seed generation step, the pH of the mixed solution containing nickel ions at a desired composition ratio is adjusted to, for example, be in a range of 11 to 13 to prepare a liquid medium containing seed crystals. The seed crystals can contain, for example, a hydroxide containing nickel at a desired ratio. The mixed solution can be prepared by dissolving a nickel salt in water at a desired ratio. Examples of the nickel salt include sulfates, nitrates, and hydrochlorides. The mixed solution may contain other metal salts at a desired composition ratio as necessary in addition to the nickel salt. The temperature in the seed generation process can be, for example, in a range of 40° C. to 80° C. The atmosphere in the seed generation process can be a low oxidizing atmosphere, and for example, the oxygen concentration can be kept at 10 vol % or less.

In the crystallization step, the generated seed crystals are grown to obtain a nickel-containing precipitate having a desired composition. The seed crystals can be grown, for example, by adding a mixed solution containing nickel ions and other metal ions as necessary to a liquid medium containing the seed crystals while keeping the pH at, for example, in a range of 7 to 12.5, preferably 7.5 to 12. The time for adding the mixed solution is, for example, in a range of 1 hour to 24 hours, preferably 3 hours to 18 hours. The temperature in the crystallization step may be, for example, in a range of 40° C. to 80° C. The atmosphere in the crystallization step is the same as that in the seed generation process. The pH in the seed generation step and the crystallization step can be adjusted using an acidic aqueous solution such as an aqueous sulfuric acid solution or an aqueous nitric acid solution, an alkaline aqueous solution such as an aqueous sodium hydroxide solution or an aqueous ammonia solution, or the like.

In the step of obtaining a composite oxide, the precipitate (including, for example, a composite hydroxide) obtained in the crystallization process is heat-treated to obtain the composite oxide. The heat treatment in the step of obtaining a composite oxide can be performed by heating the composite hydroxide precipitate at a temperature of, for example, 500° C. or lower, preferably at 450° C. or lower. The temperature of the heat treatment is, for example, 100° C. or higher, preferably 200° C. or higher, and the time of the heat treatment can be, for example, in a range of 0.5 to 48 hours, preferably 5 to 24 hours. The atmosphere of the heat treatment may be atmospheric air or an atmosphere containing oxygen. The heat treatment can be performed using, for example, a box furnace, a rotary kiln furnace, a pusher furnace, a roller hearth kiln furnace, or the like.

The composite oxide obtained may contain cobalt in addition to nickel. In the case where the composite oxide contains other metals, the mixed solution may contain the other metal ions in a desired composition in the seed generation step and the crystallization step. This allows the precipitate to contain nickel, cobalt, and the other metals, so that the composite oxide with a desired composition can be obtained by heat treating the precipitate.

The obtained composite oxide may contain another metal element M¹ in addition to nickel. Examples of another metal element M¹ include Mn, Al, etc., and at least one selected from the group consisting of these is preferable, and it is more preferable to contain at least Mn. In the case where the composite oxide contains another metal element, the mixed solution in the seed generation step and the crystallization step may contain another metal ions in a desired composition. This allows the precipitate to contain nickel and another metal element so that the composite oxide with a desired composition can be obtained by heat-treating the precipitate.

The average particle diameter of the composite oxide may be, for example, 2 μm or more and 20 μm or less, preferably 3 μm or more and 10 μm or less. The average particle diameter of the composite oxide is a volume average particle diameter, and is a value at which the volume integrated value from the small particle diameter side in the volume-based particle size distribution obtained by the laser scattering method is 50%.

In the synthesis step, a mixture containing lithium obtained by mixing the composite oxide with a lithium compound is heat-treated to obtain a heat-treated product. The obtained heat-treated product has a layered structure and contains a lithium transition metal composite oxide containing nickel.

Examples of the lithium compound to be mixed with the composite oxide include lithium hydroxide, lithium carbonate, lithium oxide, etc. The particle diameter of the lithium compound used for mixing may be, for example, 0.1 μm or more and 100 μm or less, preferably 2 μm or more and 20 μm or less, as the 50% average particle diameter of the cumulative particle size distribution based on volume.

The ratio of the total number of moles of lithium to the total number of moles of metal elements constituting the composite oxide in the mixture may be, for example, 0.95 or more and 1.5 or less. The composite oxide and the lithium compound can be mixed using, for example, a high-speed shear mixer.

The mixture may further contain another metal element M¹ or M² other than lithium, nickel, and cobalt. As another metal element M¹, at least one metal element selected from the group consisting of manganese and aluminum is preferable. Examples of another metal element M² include B, Na, Mg, Si, P, S, K, Ca, Ti, V, Cr, Zn, Sr, Y, Zr, Nb, Mo, In, Sn, Ba, La, Ce, Nd, Sm, Eu, Gd, Ta, W, and Bi, and at least one selected from the group consisting of these is preferable.

In the case where the mixture contains another metal element, a mixture can be obtained by mixing a simple substance or a metal compound of another metal element with the composite oxide and the lithium compound. Examples of metal compounds containing another metal element include oxides, hydroxides, chlorides, nitrides, carbonates, sulfates, nitrates, acetates, oxalates, etc.

In the case where the mixture contains other metal elements, the ratio of the total number of moles of the metal elements constituting the composite oxide to the total number of moles of the other metal elements is, for example, in a range of 1:0.001 to 1:0.3, preferably 1:0.01 to 1:0.15.

The heat treatment temperature of the mixture may be, for example, 550° C. or higher and 1,100° C. or lower, preferably 600° C. or higher and 1,080° C. or lower, and more preferably 700° C. or higher and 1,080° C. or lower. The heat treatment of the mixture may be performed at a single temperature, but is preferably performed at a plurality of temperatures in terms of discharge capacity at high voltage. In the case of heat treating the mixture at a plurality of temperatures, for example, it is desirable to hold a first temperature for a predetermined time and then further increase the temperature and hold a second temperature for a predetermined time, and further heat treat the mixture at a third temperature lower than the second temperature to obtain a heat-treated product.

Furthermore, by performing heat treatment for a predetermined period of time at a third temperature during the temperature drop after heat treatment at the first or second temperature, the effect of reducing the disorder value of the nickel element described above tends to be obtained.

The first temperature may be, for example, 300° C. or higher and 600° C. or lower, preferably 350° C. or higher and 550° C. or lower. The second temperature may be, for example, 800° C. or higher and 1,100° C. or lower, preferably 850° C. or higher and 1,050° C. or lower. The third temperature may be, for example, 600° C. or higher and 850° C. or lower, preferably 700° C. or higher and 800° C. or lower.

In the case where heat treatment is performed at a single temperature, the heat treatment time may be, for example, 1 hour or more and 20 hours or less, preferably 5 hours or more and 15 hours or less. In the case of performing heat treatment at a plurality of temperatures, the heat treatment time at the first temperature may be, for example, 1 hour or more and 20 hours or less. The heat treatment time at the second temperature may be, for example, 1 hour or more and 20 hours or less. The heat treatment times at each temperature may be the same or different, and may be performed successively or separately.

The atmosphere of the heat treatment may be atmospheric air or an atmosphere containing oxygen. The heat treatment may be performed using, for example, a box furnace, a rotary kiln furnace, a pusher furnace, a roller hearth kiln furnace, or the like.

The heat-treated product is subjected to a dispersion treatment as necessary. The sintered primary particles are dissociated by a dispersion treatment, not by a pulverization treatment involving strong shearing force or impact, to obtain lithium transition metal composite oxide particles having a narrow particle size distribution and uniform particle size. The dispersion treatment may be performed in a dry or wet manner, and is preferably performed in a dry manner. The dispersion treatment can be performed using, for example, a ball mill, a jet mill, or the like. The conditions of the dispersion treatment can be set, for example, so that the D₅₀/D_{SEM} of the lithium transition metal composite powder after the dispersion treatment is in a desired range, for example, 1 or more and 4 or less.

For example, in the case of performing the dispersion treatment by a ball mill, resin media can be used. Examples of the material of the resin media include urethane resin and nylon resin. Generally, alumina, zirconia, and the like are used as the material of the media of the ball mill, and the particles are pulverized by these media. In contrast, by using the resin media, the sintered primary particles are dissociated without pulverizing the particles. The size of the resin media can be, for example, in a range of 5 mm to 30 mm. For the body (shell), for example, urethane resin, nylon resin, and the like can be used. The time of the dispersion treatment may be, for example, in a range of 3 minutes to 60 minutes, and is preferably in a range of 10 minutes to 30 minutes. As the conditions of the dispersion treatment by the ball mill, the amount of media, the rotation or amplitude speed, the dispersion time, the media specific gravity, and the like may be adjusted so that the desired D₅₀/D_{SEM} can be achieved.

For example, in the case where the dispersion treatment is carried out using a jet mill, the supply pressure, grinding pressure, etc. may be adjusted so that the desired D₅₀/D_{SEM} can be achieved without pulverizing the primary particles. The supply pressure may be, for example, in a range of 0.1 MPa to 0.6 MPa, and the grinding pressure may be, for example, in a range of 0.1 MPa to 0.6 MPa.

### First Adhesion Step

In the first adhesion step, the provided lithium transition metal composite powder is brought into contact with a cobalt raw material to obtain a cobalt-adhered composite oxide in which the cobalt raw material is adhered to the surface of the lithium transition metal composite powder. The contact between the lithium transition metal composite powder and the cobalt raw material may be performed in a dry or wet manner.

In the case where the first adhesion step is performed in a dry manner, the lithium transition metal composite powder and the cobalt raw material can be mixed and brought into contact with each other. Examples of the cobalt raw material include cobalt hydroxide, cobalt oxide, and cobalt carbonate. In the case of performing the first adhesion step in a dry manner, the advantages may be expected that the number of processes is reduced compared to the wet method and that the reduction in the amount of lithium contained in the lithium transition metal composite powder can be inhibited.

Examples of the means for mixing include a high-speed shear mixer, a Henschel mixer, a high-speed mixer, a bead mill, a ball mill, and the like.

In the case where the first adhesion step is performed in a wet manner, the lithium transition metal composite powder can be brought into contact with a liquid medium containing a cobalt raw material, so that the lithium transition metal composite powder can come into contact with the cobalt raw material. At this time, the liquid medium may be stirred as necessary. The liquid medium containing the cobalt raw material may be a solution of the cobalt raw material or a dispersion of the cobalt raw material. Alternatively, the lithium transition metal composite powder may be suspended in a solution of the cobalt raw material, and the cobalt raw material may be precipitated in the solution by adjusting the pH, adjusting the temperature, or the like, to adhere the cobalt raw material to the surface of the lithium transition metal composite powder.

In the case of performing the first adhesion step by a wet manner, examples of the cobalt raw material contained in the solution used for bringing into contact with the cobalt raw material include cobalt sulfate, cobalt nitrate, and cobalt chloride. Examples of the cobalt raw material contained in the dispersion liquid used for bringing into contact with the cobalt raw material include cobalt hydroxide, cobalt oxide, and cobalt carbonate. The liquid medium contain water, for example, and may contain a water-soluble organic solvent such as alcohol in addition to water. The concentration of the cobalt raw material in the liquid medium may be, for example, 1 mass % or more and 8.5 mass % or less.

The total number of moles of cobalt atoms contained in the cobalt raw material to be brought into contact with the lithium transition metal composite powder may be, for example, 0.5 mol % or more and 15 mol % or less, preferably 1 mol % or more and 10 mol % or less, of the total number of moles of metal atoms other than lithium contained in the lithium transition metal composite powder.

The contact temperature at which the lithium transition metal composite powder and the cobalt raw material are brought into contact with each other may be, for example, 40° C. or higher and 80° C. or lower, preferably 40° C. or higher and 60° C. or lower. The contact temperature may be, for example, 20° C. or higher and 80° C. or lower. The contact time may be, for example, 30 minutes or more and 180 minutes or less, preferably 30 minutes or more and 60 minutes or less.

After bringing into contact with the liquid medium containing the cobalt raw material, the cobalt-adhered composite oxide may be subjected to treatment such as filtration, washing with water, drying, etc., as necessary. In addition, a preliminary heat treatment may be performed depending on the type of the cobalt raw material to be adhered. In the case where the preliminary heat treatment is performed, the temperature may be, for example, 100° C. or higher and 350° C. or lower, preferably 120° C. or higher and 320° C. or lower. The treatment time may be, for example, 5 hours or more and 20 hours or less, preferably 8 hours or more and 15 hours or less. The atmosphere of the preliminary heat treatment may be, for example, an oxygen-containing atmosphere or an air atmosphere.

### First Heat Treatment Step

In the first heat treatment step, the cobalt-adhered composite oxide obtained in the first adhesion step is heat-treated at a predetermined temperature higher than 600° C. and lower than 800° C. to obtain a heat-treated product. A cathode active material containing a lithium transition metal composite oxide having a desired cobalt concentration gradient depending on the heat treatment temperature can be obtained, and good output characteristics can be achieved in an all-solid-state secondary battery configured using this.

The production method may include a mixing step of mixing the cobalt-adhered composite oxide and a lithium compound to obtain a mixture, prior to the first heat treatment step.

Examples of the lithium compound to be mixed with the cobalt-adhered composite oxide include lithium hydroxide, lithium carbonate, lithium chloride, etc. The amount of the lithium compound added for mixing is such that the mole ratio of lithium to cobalt (Li:Co) with respect to the amount of cobalt adhered in the first adhesion step is, for example, in a range of 0.95:1 to 1.50:1, preferably 1.00:1 to 1.30:1. The mixing can be performed using, for example, a high-speed shear mixer.

The temperature of the first heat treatment of the cobalt-adhered composite oxide may be, for example, more than 600° C. and less than 800° C. The first heat treatment temperature may be preferably 650° C. or higher, more preferably 675° C. or higher, or 690° C. or higher. The first heat treatment temperature may be preferably 760° C. or lower, or 750° C. or lower, more preferably 725° C. or lower, or 715° C. or lower. The time of the first heat treatment may be, for example, 1 hour or more and 20 hours or less, preferably 3 hours or more and 10 hours or less. The atmosphere of the heat treatment preferably contains oxygen. The heat treatment under an atmosphere containing oxygen allows for, for example, reducing the amount of residual lithium and more effectively inhibiting sintering between particles. In the case where the heat treatment atmosphere contains oxygen, its content is preferably 15 vol % or more, more preferably 30 vol % or more, and even more preferably 80 vol % or more.

After the first heat treatment, the first heat-treated product may be subjected to treatments such as crushing, pulverization, classification, and particle size regulation, if necessary.

In the surface composition of the first heat-treated product, the larger the ratio of the number of moles of cobalt to the total number of moles of metals other than lithium (hereinafter, also simply referred to as “cobalt ratio”), the more likely it is that the adhesion of niobium after the second adhesion step described below will be uniform. The cobalt ratio in the surface composition of the first heat-treated product may be 10 mol % or more, preferably 15 mol % or more, and more preferably 25 mol % or more. The cobalt ratio is preferably 40 mol % or less. In the case of 40 mol % or less, there is a tendency that sufficient discharge capacity can be obtained.

The surface composition of the first heat-treated product can be determined by stirring the first heat-treated product in an acidic solvent for a short period of time and subjecting the eluate to high-frequency inductively coupled plasma emission spectroscopy (ICP). Detailed conditions thereof will be described later, but this technique is referred to as surface elution analysis in this description.

The first heat-treated product obtained as described above contains a lithium transition metal composite oxide having a cobalt concentration gradient.

### Second Adhesion Step

In the second adhesion step, the first heat-treated product is brought into contact with a niobium raw material to obtain a niobium-adhered composite oxide. The contact between the first heat-treated product and the niobium raw material may be performed in a dry or wet manner.

In the case of a dry process, the first heat-treated product and a niobium raw material can be mixed to be brought into contact with each other.

The niobium raw material can be, for example, niobium oxide.

Examples of the means for mixing include a high-speed shear mixer, a Henschel mixer, a high-speed mixer, a bead mill, a ball mill, and the like.

In the case of a wet process, the first heat-treated product may be brought into contact with a liquid medium containing a niobium raw material. At this time, the liquid medium may be stirred as necessary. The liquid medium containing the niobium raw material may be a solution of the niobium raw material or a dispersion of the niobium raw material. The first heat-treated product may be suspended in a solution of the niobium raw material to allow the niobium raw material to precipitate in the solution by adjusting the pH, adjusting the temperature, etc., whereby the niobium raw material may be adhered to the surface of the first heat-treated product.

The niobium raw material may be adhered to the surface of the first heat-treated product using a tumbling fluidized bed dryer.

Examples of the niobium raw material contained in the solution include niobic acid, pentaethoxyniobium, and niobium chloride. Examples of the niobium raw material contained in the dispersion include niobic acid, pentaethoxyniobium, and niobium chloride. The liquid medium contain, for example, water, and may contain alcohol, hydrogen peroxide, ammonia water, and the like in addition to water. The concentration of the niobium raw material in the liquid medium may be, for example, 0.5% by mass or more and 3% by mass or less.

The total number of moles of niobium atoms contained in the niobium raw material to be brought into contact with the first heat-treated product may be, for example, 0.1 mol % or more and 5 mol % or less, preferably 0.5 mol % or more and 3 mol % or less, or 0.8 mol % or more and 2 mol % or less, of the total number of moles of metal atoms other than lithium contained in the first heat-treated product.

The contact temperature between the first heat-treated product and the niobium raw material may be, for example, 20° C. or higher and 200° C. or lower, preferably 40° C. or higher and 150° C. or lower. The contact time may be, for example, 30 minutes or more and 180 minutes or less, preferably 30 minutes or more and 120 minutes or less.

After bringing into contact with the liquid medium containing the niobium raw material, the niobium-adhered composite oxide may be subjected to treatments such as filtration, washing with water, drying, etc., as necessary.

### Second Heat Treatment Step

In the second heat treatment step, the niobium-adhered composite oxide obtained in the second adhesion step is heat-treated at a predetermined temperature higher than 300° C. and less than 500° C. to obtain a second heat-treated product.

The niobium-adhered composite oxide subjected to the second heat treatment may be a mixture with a lithium compound. That is, the production method may include a mixing step of mixing the niobium-adhered composite oxide with a lithium compound to obtain a mixture, before the heat treatment step.

Examples of the lithium compound to be mixed with the cobalt-adhered composite oxide include lithium hydroxide, lithium carbonate, lithium chloride, etc. The amount of the lithium compound added for mixing is such that the mole ratio of lithium to niobium (Li:Nb) is, for example, in a range of 0.95:1 to 1.50:1, preferably 1.00:1 to 1.30:1 relative to the amount of niobium adhered in the adhesion step. The mixing can be performed using, for example, a high-speed shear mixer.

The temperature of the second heat treatment of the niobium-adhered composite oxide may be, for example, more than 300° C. and less than 500° C. The second heat treatment temperature may be preferably 320° C. or higher, more preferably 340° C. or higher. The second heat treatment temperature may be preferably 450° C. or lower, more preferably 400° C. or lower, 380° C. or lower, or 360° C. or lower. The time of the second heat treatment may be, for example, 1 hour or more and 20 hours or less, preferably 3 hours or more and 10 hours or less. The atmosphere of the second heat treatment may be, for example, an oxygen-containing atmosphere, which may be an air atmosphere.

The heat-treated product after the second heat treatment may be subjected to further treatments such as crushing, pulverization, classification, and particle size adjustment, if necessary.

The second heat-treated product obtained in the above manner may contain a lithium transition metal composite oxide, have a cobalt concentration gradient, and have a secondary particle surface containing a niobium compound on at least a part of the particle surface. That is, in the lithium transition metal composite oxide, the ratio of the number of moles of cobalt to the total number of moles of metals other than lithium may be 0 or more in a first region at a depth of about 60 nm from the secondary particle surface, and may be 0.15 or more in a second region at a depth of about 10 nm from the secondary particle surface. The first region may be a region at a depth from the secondary particle surface in the range of, for example, 50 nm to 70 nm, or 55 nm to 65 nm, and the second region may be a region at a depth from the secondary particle surface in the range of, for example, 5 nm to 15 nm.

### Cathode Active Material for Secondary Battery

The cathode active material for a secondary battery includes a lithium transition metal composite oxide having a layered structure and a composition in which the ratio of the number of moles of nickel to the total number of moles of metals other than lithium is 0.5 or more and less than 1 and in which the ratio of the number of moles of cobalt to the total number of moles of metals other than lithium is 0.01 or more and less than 0.5. The lithium transition metal composite oxide has a secondary particle surface containing a niobium compound on at least a part of the particle surface, wherein when a region located at a depth of approximately 60 nm from the secondary particle surface is defined as a first region and a region located at a depth of approximately 10 nm from the surface of the coating portion is defined as a second region, the second region has a higher cobalt concentration than the first region.

High charge/discharge capacity and good output characteristics may be achieved in an all-solid-state secondary battery comprising the cathode active material including the lithium transition metal composite oxide that has the secondary particle surface containing a niobium compound and that has the first and second regions in which the ratio of the number of moles of nickel in the composition is within a specific range, wherein the cobalt concentration in the second region is higher than the cobalt concentration in the first region. This is thought to be because, for example, although increase in the ratio of the number of moles of nickel in the composition leads to the reduction in the lithium-ion conductivity while leading to higher charge/discharge capacity, having higher cobalt concentration in the second region inhibits the reduction in the lithium-ion conductivity. Furthermore, it is thought that having a niobium compound on the secondary particle surface can prevent the formation of a high resistance layer between the surface and the solid electrolyte.

The ratio of the molar amount of niobium atoms contained in the niobium compound may be 0.1 mol % or more relative to the total number of moles of metal atoms other than lithium contained in the lithium transition metal composite oxide. From the viewpoint of reducing side reactions with the solid electrolyte, it may be 0.5 mol % or more, more preferably 0.8 mol % or more. The ratio of the molar amount of niobium atoms contained in the niobium compound may be 5 mol % or less relative to the total number of moles of the lithium transition metal composite oxide, and from the viewpoint of resistance and capacity, it may be 4 mol % or less, more preferably 3 mol % or less, 2 mol % or less, or 1.5 mol % or less.

Examples of the niobium compound include lithium niobate. By coating the secondary particle surface of the lithium transition metal composite oxide with a niobium compound such as lithium niobate, an effect is obtained that the formation of a high resistance layer at the interface between the lithium transition metal composite oxide and the sulfide solid electrolyte is prevented, and an improvement in output is expected. Furthermore, by inhibiting the side reaction between the lithium transition metal composite oxide and the sulfide solid electrolyte, deterioration of the cathode can be inhibited, and improvement in cycle characteristics can also be expected.

The thickness of the niobium compound may be, for example, 30 nm or less, and is preferably 20 nm or less from the viewpoints of resistance and capacitance.

The composition of the lithium transition metal composite oxide contained in the cathode active material can be considered to be a composition of the lithium transition metal composite oxide before adhering the niobium raw material in the producing method described above, plus the niobium raw material adhered.

In the lithium transition metal composite oxide constituting the cathode active material, cobalt is unevenly distributed and its concentration is higher in the second region. The existence form of cobalt in the second region is not clearly known, but is, thought to be, for example, a form in which cobalt is solid-dissolved in the second region of the lithium transition metal composite oxide, a form in which a cobalt compound such as lithium cobaltate is present in the second region, or the like. This can improve the output characteristics when a battery is constructed using such a cathode active material. The reason for this is not clear, but the following can be inferred as an example. It is thought that, in the case where cobalt exists as lithium cobaltate, as an existence form of cobalt, in the second region, lithium-ion conductivity of lithium cobaltate is higher than that of the first region with a high nickel ratio or that of the coating portion of niobium compound, so that the diffusion of lithium ions in the cathode active material as a whole is facilitated and the output characteristics are improved.

The effect of improving the output characteristics due to the denser distribution of cobalt in the second region of the secondary particles is more effectively achieved in the case of single particles having a D₅₀/D_{SEM} of 4 or less than in the case of so-called aggregated particles in which a large number of primary particles are aggregated with the D₅₀/D_{SEM} greater than 4.

This can be considered, for example, as follows. It is thought that, because a three-dimensional grain boundary network is formed in the aggregated particles, the output characteristics are improved by grain boundary conduction. On the other hand, though it is difficult to fully utilize grain boundary conduction in the single particles, it can be considered that the improvement in lithium conductivity due to the denser distribution of cobalt in the second region of the particles is more effectively achieved, thereby further improving the output characteristics.

The lithium transition metal composite oxide may be composed of secondary particles each formed by aggregation of more than 20 primary particles, but is preferably in the form of particles each consisting of secondary particles composed of 20 or less, preferably 10 or less primary particles or single particles, i.e., so-called single particles. The lithium transition metal composite powder in the single particle form may have D₅₀/D_{SEM} of 1 or more and 4 or less that is a ratio of the 50% particle diameter D₅₀ in the cumulative particle size distribution on a volume basis to the average particle diameter D_{SEM} based on observation with a scanning electron microscope (SEM).

The lithium transition metal composite oxide contained in the cathode active material may have a D₅₀/D_{SEM} of, for example, 1 or more and 4 or less, and from the viewpoint of output density, it is preferably 3.5 or less, more preferably 3 or less, even more preferably 2.5 or less, and particularly preferably 2 or less, or 1.5 or less. It may be expected that the closer D₅₀/D_{SEM} is to 1, the greater the effect of improving the output characteristics when the second region has a higher cobalt concentration than the first region. The method of measuring the average particle diameter D_{SEM} and 50% particle diameter D₅₀ based on electron microscope observation is as described above.

In the lithium transition metal composite oxide, the average particle diameter D_{SEM} based on electron microscope observation may be, for example, 0.1 μm or more and 20 μm or less from the viewpoint of durability. The average particle diameter D_{SEM} based on electron microscope observation is preferably 0.3 μm or more, more preferably 0.5 μm or more or 1 μm or more from the viewpoint of power density and packing performance in an electrode plate. The average particle diameter D_{SEM} based on electron microscope observation is preferably 15 μm or less, more preferably 10 μm or less, even more preferably 8 μm or less, and particularly preferably 5 μm or less, 4 μm or less, or 3 μm or less.

The 50% particle diameter D₅₀ of the lithium transition metal composite oxide may be, for example, 1 μm or more and 30 μm or less, preferably 1.5 μm or more, more preferably 3 μm or more, and from the viewpoint of power density, preferably 10 μm or less, more preferably 5.5 μm or less.

The lithium transition metal composite oxide may have a D₉₀/D₁₀ of, for example, 4 or less, and from the viewpoint of power density, preferably 3 or less, and more preferably 2.5 or less. The D₉₀/D₁₀ may be, for example, 1.2 or more.

In the lithium transition metal composite oxide, the ratio of the number of moles of nickel to the total number of moles of metals other than lithium in the first region, which is about 60 nm deep from the secondary particle surface (hereinafter, also referred to simply as the “nickel ratio”), may be, for example, 0.5 or more or 0.6 or more, preferably 0.7 or more or 0.8 or more. The nickel ratio of the first region may be, for example, 1 or less, preferably 0.95 or less or 0.9 or less. The nickel ratio of the second region, which is about 10 nm deep from the secondary particle surface, may be, for example, 0.8 or less or 0.7 or less, preferably 0.6 or less or 0.55 or less. The nickel ratio of the second region may be, for example, 0.4 or more or 0.5 or more. Furthermore, the value obtained by dividing the nickel ratio of the second region by the nickel ratio of the first region may be, for example, less than 1, preferably 0.9 or less or 0.8 or less. The value obtained by dividing the nickel ratio of the second region by the nickel ratio of the first region may be, for example, 0.3 or more, preferably 0.4 or more or 0.5 or more. When the nickel ratios of the first region and the second region are in the above ranges, the effect of improving output is greater if the secondary particle surface has a Co concentration gradient.

Furthermore, in the lithium transition metal composite oxide, the ratio of the number of moles of cobalt to the total number of moles of metals other than lithium (hereinafter, also referred to simply as “cobalt ratio”) is larger in the second region than in the first region. The cobalt ratio of the first region may be, for example, 0 or more, preferably 0.02 or more or 0.03 or more. The cobalt ratio of the first region may be, for example, 0.5 or less, preferably 0.3 or less, more preferably 0.2 or less, even more preferably 0.1 or less, and particularly preferably 0.05 or less. The cobalt ratio of the second region may be, for example, 0.1 or more, preferably 0.2 or more, 0.22 or more, or 0.25 or more. The cobalt ratio of the second region may be, for example, 0.5 or less, 0.4 or less, or 0.3 or less. The value obtained by dividing the cobalt ratio of the second region by the sum of the cobalt ratio of the first region and the cobalt ratio of the second region may be, for example, greater than 1, preferably 3 or more, and more preferably 5 or more.

The nickel ratio and cobalt ratio in the first region and the second region can be calculated by performing line analysis using SEM-EDX on a cross section of the lithium transition metal composite oxide.

In the lithium transition metal composite oxide, the cobalt ratio may decrease continuously or discontinuously from the secondary particle surface to the interior of the secondary particle. The concentration gradient of cobalt, which is the absolute value of a value obtained by dividing a difference in the ratio of the number of moles of cobalt to the total number of moles of metals other than lithium between the first region and the second region by a difference in depth from the surface between the first region and the second region, may be, for example, 0.0002 (nm⁻¹) or more, preferably 0.001 or more, more preferably 0.002 or more, 0.0025 or more, or 0.003 or more. The concentration gradient of cobalt, which is the absolute value of a quotient obtained by dividing by the difference in depth from the surface of the first region and second region, may be, for example, 0.2 (nm⁻¹) or less, preferably 0.08 (nm⁻¹) or less, more preferably 0.04 (nm⁻¹) or less, 0.02 (nm⁻¹) or less, 0.01 (nm⁻¹) or less, or 0.005 (nm⁻¹) or less. Specifically, the cobalt concentration gradient is obtained by dividing a value obtained by subtracting the cobalt ratio in the first region from the cobalt ratio in the second region by a value obtained by subtracting the depth from the surface of the first region from the depth from the surface of the second region.

The composition of the lithium transition metal composite oxide contained in the cathode active material can be considered to be a composition of the lithium transition metal composite oxide before adhering the niobium raw material in the producing method described above, plus the niobium raw material adhered.

The uniformity of the niobium compound in the surface composition of the lithium transition metal composite oxide can be evaluated using an index called SED standard deviation by analyzing SEM-EDX data. A specific measurement method thereof will be described later. The lower the value of the SED standard deviation, the more uniformly the niobium compound is distributed on the surface of the lithium transition metal composite oxide, which is preferable. When the niobium compound is distributed uniformly, the coating with the niobium compound is performed without excess or deficiency, and therefore it is expected to prevent, for example, side reactions with the solid electrolyte in an exposed portion and a decrease in conductivity in an excessively coated portion. The SED standard deviation may be 6 or less, preferably 5 or less, more preferably 4 or less, and even more preferably 3 or less.

The ratio of the number of moles of nickel to the total number of moles of metals other than lithium in the composition of the lithium transition metal composite oxide contained in the cathode active material may be, for example, 0.5 or more and less than 1. The ratio of the number of moles of nickel to the total number of moles of metals other than lithium may be preferably 0.6 or more, more preferably 0.7 or more. The ratio of the number of moles of nickel to the total number of moles of metals other than lithium may be preferably 0.95 or less, more preferably 0.92 or less, and particularly preferably 0.9 or less. When the mole ratio of nickel is in the above range, both charge/discharge capacity at high voltage and cycle characteristics can be achieved in the all solid-state secondary battery. The above ratio of the number of moles of nickel can be obtained by, for example, analyzing the metal composition ratio of the cathode active material by an inductively coupled plasma optical emission spectrometer.

The ratio of the number of moles of cobalt to the total number of moles of metals other than lithium in the composition of the lithium transition metal composite oxide contained in the cathode active material may be, for example, 0 or more, and from the viewpoint of output characteristics, may be preferably 0.01 or more, or 0.02 or more, and more preferably 0.03 or more. The ratio of the number of moles of cobalt to the total number of moles of metals other than lithium may be, for example, 0.5 or less, and from the viewpoint of charge/discharge capacity, may be preferably 0.3 or less, and more preferably 0.2 or less.

The composition of the lithium transition metal composite oxide contained in the cathode active material may further contain a metal element M¹ containing at least one selected from the group consisting of manganese and aluminum. In the case where the lithium transition metal composite oxide contains a metal element M¹, the ratio of the number of moles of M¹ to the total number of moles of metals other than lithium may be, for example, greater than 0, and from the viewpoint of safety, may be preferably 0.03 or more, more preferably 0.05 or more or 0.07 or more. The ratio of the number of moles of M¹ to the total number of moles of metals other than lithium may be, for example, 0.5 or less, and from the viewpoint of charge/discharge capacity, may be preferably 0.4 or less, more preferably 0.3 or less or 0.25 or less.

The composition of the lithium transition metal composite oxide contained in the cathode active material includes at least one selected from the group consisting of boron, sodium, magnesium, silicon, phosphorus, sulfur, potassium, calcium, titanium, vanadium, chromium, zinc, strontium, yttrium, zirconium, niobium, molybdenum, indium, tin, barium, lanthanum, cerium, neodymium, samarium, europium, gadolinium, tantalum, tungsten, bismuth, etc., and further includes a metal element M² containing at least niobium. The ratio of the number of moles of M² to the total number of moles of metals other than lithium may be, for example, greater than 0, preferably 0.005 or more, and particularly preferably 0.01 or more. The ratio of the number of moles of M² to the total number of moles of metals other than lithium may be, for example, 0.1 or less, preferably 0.05 or less, and particularly preferably 0.03 or less.

The metal element M² may contain at least niobium. The ratio of the number of moles of niobium to the total number of moles of metals other than lithium in the lithium transition composite oxide is preferably 0.005 or more from the viewpoint of output characteristics, and is preferably 0.03 or less from the viewpoint of initial capacity.

The metal element M² may further contain zirconium in addition to niobium. In the case where M² contains zirconium, the ratio of the number of moles of zirconium to the total number of moles of metals other than lithium in the lithium transition composite oxide may be 0.001 or more and 0.01 or less, or 0.002 or more and 0.005 or less, from the viewpoint of output characteristics.

The ratio of the number of moles of lithium to the total number of moles of metals other than lithium in the composition of the lithium transition metal composite oxide contained in the cathode active material may be, for example, 0.95 or more and 1.5 or less, preferably 1 or more and 1.3 or less.

When the lithium transition metal composite oxide contained in the cathode active material is represented as a composition, for example, a lithium transition metal composite oxide having a composition represented by Formula (2) below is preferable.

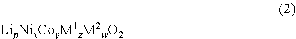

In Formula (2), 0.95≤p≤1.5, 0.5≤x<1, 0.01≤y<0.5, 0≤z<0.5, 0<w≤0.1, 0.8≤x+y+z+w≤1.2, and M¹ includes at least one selected from the group consisting of Al and Mn. M² includes at least one selected from the group consisting of B, Na, Mg, Si, P, S, K, Ca, Ti, V, Cr, Zn, Sr, Y, Zr, Nb, Mo, In, Sn, Ba, La, Ce, Nd, Sm, Eu, Gd, Ta, W, and Bi, and includes at least Nb.

In Formula (2), p may be 0.98≤p, 0.1≤p, p≤1.3, or p≤1.1. x may be 0.6≤x, 0.7≤x, x≤0.95, x≤0.92, or x≤0.9. y may be 0.02≤y, 0.03≤y, y≤0.3, or y≤0.2. z may be 0.03≤z, 0.05≤z, z≤0.5, z≤0.4, or z≤0.3.

w may be 0.0005≤w, 0.001≤w, w≤0.05, or w≤0.02. x+y+z+w may satisfy 0.9≤x+y+z+w≤1.

From the viewpoint of the initial efficiency of the secondary battery, the lithium transition metal composite oxide contained in the cathode active material has a nickel element disorder, which is determined by an X-ray diffraction method, of preferably 6% or less, 5% or less, or 4.0% or less, more preferably 2.0% or less. The nickel element disorder is as described above.

The tapped density of the cathode active material may be 1.7 g/cm³ or more. This is preferable because the volume energy density becomes sufficiently high. More preferably, it may be 2.0 g/cm³ or more. There is no particular upper limit as long as the cathode active material can have a value as a powder. In reality, the upper limit is approx. 2.5 g/cm³.

The specific surface area of the cathode active material may be, for example, 0.2 m²/g or more and 3.0 m²/g or less, preferably 0.3 m²/g or more and 2.0 m²/g or less. When the specific surface area is in the above range, the area of contact between the cathode active material and the electrolyte increases, which tends to improve the output. The specific surface area of the cathode active material is measured by the BET method.

The ratio of the 90% particle diameter D₉₀ to the 10% particle diameter D₁₀ in the cumulative particle size distribution based on the volume of the cathode active material represents the spread of the particle size distribution, and indicates that the smaller the value, the more uniform the particle size of the particles. D₉₀/D₁₀ may be, for example, 4 or less, and from the viewpoint of output density, it is preferably 3 or less, and more preferably 2.5 or less. D₉₀/D₁₀ may be, for example, 1.2 or more.

The D₅₀/D_{SEM} of the cathode active material is preferably 1 or more and 4 or less from the viewpoint of durability, and preferably 3.5 or less, more preferably 3 or less, even more preferably 2.5 or less, particularly preferably 2 or less or 1.5 or less, from the viewpoint of output density.

### Positive Electrode for Secondary Battery

The positive electrode for a secondary battery includes a current collector and a cathode active material layer disposed on the current collector and containing a cathode active material for a secondary battery. The secondary battery including such an electrode can achieve high output characteristics. The positive electrode for a secondary battery may be a positive electrode for an all-solid-state secondary battery.

Examples of the material of the current collector include aluminum, nickel, stainless steel, etc. The cathode active material layer can be formed by applying onto the current collector a cathode mixture obtained by mixing the above cathode active material, conductive material, binder, etc. with a solvent, and then performing a drying process, a pressurizing process, etc. Examples of the conductive material include natural graphite, artificial graphite, acetylene black, etc. Examples of the binder include polyvinylidene fluoride, polytetrafluoroethylene, polyamide acrylic resin, etc.

### Solid Electrolyte

The cathode active material layer preferably contains a solid electrolyte. The cathode active material layer obtained by mixing a cathode active material with a solid electrolyte tends to exhibit higher ionic conductivity. For example, sulfide-based, oxide-based, halogen-based, and other solid electrolytes have been reported as the solid electrolyte.

Examples of the crystal structure of the sulfide solid electrolyte include a Thio-LISICON type crystal structure, an LGPS type crystal structure, and an argyrodite type crystal structure.

The percentage of the solid electrolyte in the cathode active material layer may be, for example, 1 wt % to 50 wt %. It may be, for example, 5 wt % to 40 wt %, or 10 wt % to 30 wt %.

### Secondary Battery

The secondary battery includes the above positive electrode for a secondary battery. The secondary battery is configured to include a negative electrode, an electrolyte, etc., in addition to the positive electrode for a secondary battery. The secondary battery may be an all-solid-state secondary battery. For the negative electrode, solid electrolyte, etc., in the all-solid-state secondary battery, those for all-solid-state secondary batteries described in, for example, International Publication WO2018/038037, JP2022-25903A, JP2018-125214A (the entire disclosure contents of which are incorporated herein by reference) and the like can be appropriately used.

The invention according to the present disclosure may include, for example, the following aspects:

(1) A method for producing a cathode active material for a secondary battery, the method comprising: providing a lithium transition metal composite powder in which a ratio of the number of moles of nickel atoms to the total number of moles of metal atoms other than lithium is 0.5 or more and less than 1 and a ratio of the number of moles of cobalt atoms to the total number of moles of metal atoms other than lithium is 0 or more and less than 0.5, the lithium transition metal composite powder having a layered structure; contacting the lithium transition metal composite powder with a cobalt raw material to obtain a cobalt-adhered composite oxide; subjecting the cobalt-adhered composite oxide to a first heat treatment performed at a temperature higher than 600° C. and lower than 800° C. to obtain a first heat-treated product; contacting the first heat-treated product with a niobium raw material to obtain a niobium-adhered composite oxide; and subjecting the niobium-adhered composite oxide to a second heat treatment performed at a temperature higher than 300° C. and lower than 500° C. to obtain a second heat-treated product.

(2) The method for producing a cathode active material for a secondary battery according to (1), wherein D₅₀/D_{SEM}, which is a ratio of a 50% particle diameter D₅₀ of a cumulative particle size distribution based on volume to an average particle diameter D_{SEM} based on observation with an electron microscope, of the lithium transition metal composite powder is 1 or more and 4 or less.

(3) The method for producing a cathode active material for a secondary battery according to (1) or (2), wherein, in the lithium transition metal composite powder, a ratio of the number of moles of nickel atoms to the total number of moles of metal atoms other than lithium is 0.6 or more and less than 1.

(4) The method for producing a cathode active material for a secondary battery according to any of (1) to (3), wherein the obtaining the cobalt-adhered composite oxide comprises dry-mixing the lithium transition metal composite powder and the cobalt raw material.

(5) The method for producing a cathode active material for a secondary battery according to any of (1) to (4), wherein in the obtaining the cobalt-adhered composite oxide, the total molar amount of cobalt atoms contained in the cobalt raw material is 1 mol % or more and 20 mol % or less of the total molar amount of metal atoms other than lithium contained in the lithium transition metal composite powder.

(6) The method for producing a cathode active material for a secondary battery according to any of (1) to (5), wherein the cobalt raw material is cobalt oxide.

(7) The method for producing a cathode active material for a secondary battery according to any of (1) to (6), wherein the first heat treatment is performed at a temperature of 650° C. or higher and 750° C. or lower.

(8) The method for producing a cathode active material for a secondary battery according to any of (1) to (7), wherein in the obtaining the niobium-adhered composite oxide, the total molar amount of niobium atoms contained in the niobium raw material is 0.1 mol % or more and 5 mol % or less of the total molar amount of metal atoms other than lithium contained in the first heat-treated product.

(9) The method for producing a cathode active material for a secondary battery according to any of (1) to (8), wherein the second heat treatment is performed at a temperature of 350° C. or higher and 450° C. or lower.

(10) The method for producing a cathode active material for a secondary battery according to any of (1) to (9), comprising: contacting the first heat-treated product with a solution containing the niobium raw material to obtain the niobium-adhered composite oxide.

(11) The method for producing a cathode active material for a secondary battery according to any of (1) to (10), wherein the niobium raw material is niobic acid.

(12) The method for producing a cathode active material for a secondary battery according to any of (1) to (11), wherein in the lithium transition metal composite powder, a ratio of the number of moles of nickel atoms to the total number of moles of metal atoms other than lithium is 0.6 or more and less than 0.8.

(13) The method for producing a cathode active material for a secondary battery according to any of (1) to (12), wherein, in a surface composition of the lithium transition metal composite powder has determined by surface elution analysis, the ratio of the number of moles of cobalt atoms to the total number of moles of metal atoms other than lithium is 0.15 or more and 0.5 or less.

(14) The method for producing a cathode active material for a secondary battery according to any of (1) to (13), wherein the lithium transition metal composite powder has a composition represented by Formula (1) below:

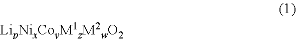

wherein in Formula (1), 0.95≤p≤ 1.5, 0.5≤x<1, 0≤y<0.5, 0≤z<0.5, 0≤w≤0.1, 0.8≤x+y+z+w≤1.2, M¹ includes at least one selected from the group consisting of Al and Mn, and M² includes at least one selected from the group consisting of B, Na, Mg, Si, P, S, K, Ca, Ti, V, Cr, Zn, Sr, Y, Zr, Nb, Mo, In, Sn, Ba, La, Ce, Nd, Sm, Eu, Gd, Ta, W, and Bi.

(15) A cathode active material for a secondary battery, comprising: a lithium transition metal composite oxide having a layered structure and having a composition in which the ratio of the number of moles of nickel atoms to the total number of moles of metal atoms other than lithium is 0.5 or more and less than 1 and in which the ratio of the number of moles of cobalt atoms to the total number of moles of metal atoms other than lithium is 0.01 or more and less than 0.5, the lithium transition metal composite oxide comprising a niobium compound on at least a part of a secondary particle surface of the lithium transition metal composite oxide, the lithium transition metal composite oxide having a higher cobalt concentration in a second region approximately 10 nm deep from the secondary particle surface than in a first region approximately 60 nm deep from the secondary particle surface.

(16) The cathode active material for a secondary battery according to (15), wherein, in the lithium transition metal composite oxide, a ratio of the number of moles of nickel atoms to the total number of moles of metal atoms other than lithium is 0.6 or more and less than 1.

(17) The cathode active material for a secondary battery according to (15) or (16), wherein, D₅₀/D_{SEM}, which is a ratio of a 50% particle diameter D₅₀ of a cumulative particle size distribution based on volume to an average particle diameter D_{SEM} based on observation with an electron microscope, of the lithium transition metal composite oxide is 1 or more and 4 or less.

(18) The cathode active material for a secondary battery according to any of (15) to (17), wherein the absolute value of a value obtained by dividing a difference between the first and second regions in the ratio of the number of moles of cobalt atoms to the total number of moles of metal atoms other than lithium by a difference between the first and second regions in depth from their respective surfaces is 0.001 (nm⁻¹) or more and 0.08 (nm⁻¹) or less.

(19) The cathode active material for a secondary battery according to any of (15) to (18), wherein the lithium transition metal composite oxide has the ratio of the number of moles of nickel atoms to the total number of moles of metal atoms other than lithium that is 0.6 or more and less than 0.8, and wherein the secondary particle surface has an SED standard deviation that is 5.0 or less for niobium as determined by SEM-EDX measurement.

(20) The cathode active material for a secondary battery according to any of (15) to (19), wherein the lithium transition metal composite oxide has a composition represented by Formula (2) below:

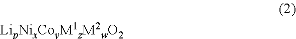

wherein in Formula (2), 0.95≤p≤1.5, 0.5≤x<1, 0.01≤y<0.5, 0≤z<0.5, 0<w≤0.1, 0.8≤x+y+z+w≤1.2, and M¹ includes at least one selected from the group consisting of Al and Mn, and M² includes at least one selected from the group consisting of B, Na, Mg, Si, P, S, K, Ca, Ti, V, Cr, Zn, Sr, Y, Zr, Nb, Mo, In, Sn, Ba, La, Ce, Nd, Sm, Eu, Gd, Ta, W, and Bi, and includes at least Nb.

(21) A positive electrode for a secondary battery, comprising: a cathode active material layer containing the cathode active material for a secondary battery according to (20).

(22) A secondary battery comprising: the positive electrode for a secondary battery according to (21); a negative electrode; and an electrolyte.

### EXAMPLES

The present invention will now be described in more detail by way of examples, but the present invention is not limited to these examples.

### Reference Example 1

A lithium transition metal composite powder having a composition represented by a composition Formula: Li_{1.05}Ni_{0.887}Co_{0.03}Mn_{0.07}Al_{0.01}Zr_{0.003}O₂ was provided by a known method. The composition ratios of metal elements other than Li are shown in Table 1.

### Example 1

### (First Adhesion Step and First Heat Treatment Step)

1,000 g of the lithium transition metal composite powder provided in Reference Example 1 and 17.6 g of cobalt oxide (Co₃O₄) were mixed in a dry mixer for 5 minutes. The number of moles of cobalt atoms contained in the cobalt oxide used was 2.0% of the total number of moles of metal atoms other than lithium contained in the lithium transition metal composite powder. Then, the mixture was heat-treated at 705° C. for 6 hours in an oxygen atmosphere to obtain a first heat-treated product having a composition represented by a composition Formula: Li_{1.03}Ni_{0.866}Co_{0.051}Mn_{0.07}Al_{0.01}Zr_{0.003}O₂.

### (Second Adhesion Step and Second Heat Treatment Step)

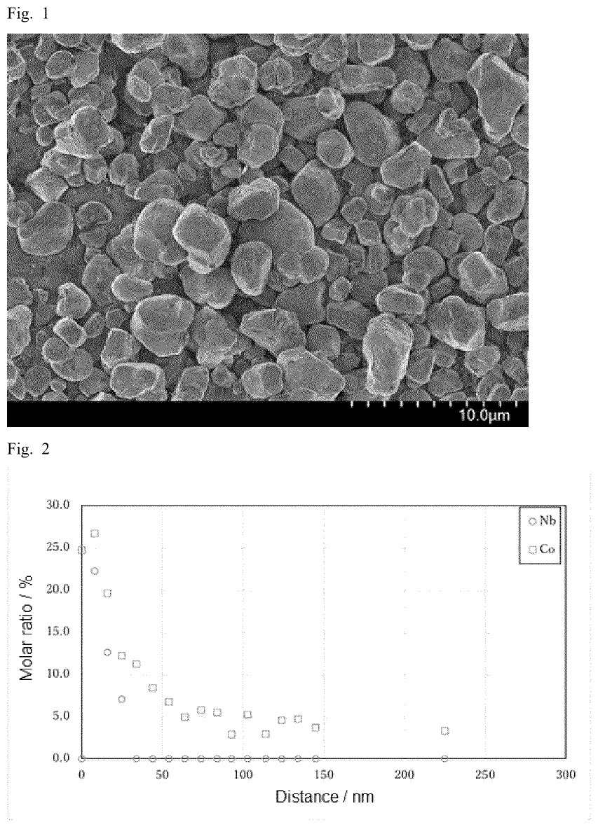

Niobium acid (Nb₂O₅·H₂O), ammonia (NH₃), and hydrogen peroxide (H₂O₂) were dissolved in water as a solvent to obtain a niobium aqueous solution. The concentrations of niobium, ammonia, and hydrogen peroxide in the niobium aqueous solution were 0.11 mol/L, 0.44 mol/L, and 2.4 mol/L, respectively. 1,000 g of the cobalt-adhered composite oxide obtained above was fed into a tumbling fluidized bed dryer and fluidized at an air flow of 0.7 m³/hr and a set temperature of 140° C., and the spray solution of the niobium aqueous solution was sprayed at a flow rate of 9 g/min for 100 minutes. Thereafter, the mixture was fluidized and dried for 10 minutes at an air flow of 0.7 m³/min and a set temperature of 140° C., and the obtained composite oxide was then heat-treated at 350° C. for 5 hours in an air atmosphere to obtain a cathode active material according to Example 1 having a composition represented by a composition Formula: Li_{1.02} Ni_{0.856} Co_{0.051} Mn_{0.07} Al_{0.01} Zr_{0.003} Nb_{0.01} O₂. The composition ratios of metal elements other than Li are shown in Table 1. Note that Co in the composition Formula includes also Co in the second region. An SEM image of the obtained cathode active material is shown in FIG. 1.

### Comparative Example 1

Except for not carrying out the first adhesion step and the first heat treatment step, a cathode active material and a battery were produced in the same manner as in Example 1. Table 1 shows the charging composition ratios of the metal elements other than Li.

TABLE 1

| | | | Co coat | Nb coat |
|---|---|---|---|---|
| | Li / Me | Ni / Co / Mn / Al / Zr / Nb | (mol %) | (mol %) |
| Example 1 | 1.02 | 85.6 / 5.1 / 7 / 1 / 0.3 / 1 | 2.0 | 1 |
| Comparative | 1.04 | 87.7 / 3 / 7 / 1 / 0.3 / 1 | — | 1 |
| Example 1 | | | | |
| Reference | 1.05 | 88.7 / 3 / 7 / 1 / 0.3 / 0 | — | — |
| Example 1 | | | | |

### Example 2

A cathode active material according to Example 2 represented by a composition Formula: Li_{1.03}Ni_{0.688}Co_{0.0981}Mn_{0.196}Al_{0.005}Zr_{0.003} Nb_{0.01}O₂ was obtained in the same manner as in Example 1, except that the prepared lithium transition metal composite powder was represented by Li_{1.02}Ni_{0.708}Co_{0.081}Mn_{0.202}Al_{0.005}Zr_{0.003}O₂ and that the temperature at the first heat treatment step was 660° C.

### Example 3

A cathode active material according to Example 3 represented by the composition Formula: Li_{1.03}Ni_{0.688}Co_{0.0981}Mn_{0.196}Al_{0.005}Zr_{0.003}Nb_{0.01}O₂ was obtained in the same manner as in Example 2, except that the temperature at the first heat treatment step was 700° C.

### Example 4

A cathode active material according to Example 4 represented by the composition Formula: Li_{1.03}Ni_{0.688}Co_{0.0981}Mn_{0.196}Al_{0.005}Zr_{0.003} Nb_{0.01}O₂ was obtained in the same manner as in Example 2, except that the temperature at the first heat treatment step was 740° C.

### Example 5

A cathode active material according to Example 5 represented by the composition Formula: Li_{1.03}Ni_{0.688}Co_{0.0981}Mn_{0.196}Al_{0.005}Zr_{0.003} Nb_{0.01}O₂ was obtained in the same manner as in Example 3, except that the lithium transition metal composite powder prepared was represented by Li_{1.02}Ni_{0.723}Co_{0.063}Mn_{0.202}Al_{0.005}Zr_{0.003}O₂ and that the amount of cobalt oxide used in the first adhesion step was 35.6 g.

### Example 6

A cathode active material according to Example 6 represented by the composition Formula: Li_{1.03}Ni_{0.688}Co_{0.0981}Mn_{0.196} Al_{0.005}Zr_{0.003} Nb_{0.01}O₂ was obtained in the same manner as in Example 5, except that the temperature at the first heat treatment step was 740° C.

### Example 7

A cathode active material according to Example 7 represented by a composition Formula: Li_{1.01}Ni_{0.688}Co_{0.0981}Mn_{0.196}Al_{0.005}Zr_{0.003}Nb_{0.01}O₂ was obtained in the same manner as in Example 6, except that the prepared lithium transition metal composite powder was represented by Li_{1.00}Ni_{0.739}Co_{0.047}Mn_{0.212}Al_{0.005}Zr_{0.003}O₂ and that the amount of cobalt oxide used at the first adhesion step was 54.6 g.

### Comparative Example 2

A cathode active material according to Comparative Example 2 represented by the composition Formula Li_{1.00}Ni_{0.739}Co_{0.047}Mn_{0.212}Al_{0.005}Zr_{0.003}O₂ was obtained in the same manner as in Comparative Example 1 except that the lithium transition metal composite powder prepared was represented by Li_{1.08}Ni_{0.700}Co_{0.10}Mn_{0.20}Al_{0.005}Zr_{0.003}O₂.

### Reference Example 2

A cathode active material having the composition Formula: Li_{1.08}Ni_{0.700}Co_{0.10}Mn_{0.20}Al_{0.005}Zr_{0.003}O₂ was prepared. Neither Co coating nor Nb coating were performed.

Table 2 shows the lithium ratio, Co coating amount, and Nb coating amount for Examples 2 to 7 and Comparative Example 2.

TABLE 2

| | | Co coat | Nb coat |
|---|---|---|---|
| | Li / Me | (mol %) | (mol %) |
| Example 2 | 1.03 | 2.0 | 1 |
| Example 3 | 1.03 | 2.0 | 1 |
| Example 4 | 1.03 | 2.0 | 1 |
| Example 5 | 1.03 | 4.0 | 1 |
| Example 6 | 1.03 | 4.0 | 1 |
| Example 7 | 1.01 | 6.1 | 1 |
| Comparative | 1.09 | 0 | 1 |
| Example 2 | | | |

### SED Standard Deviation Evaluation

SEM-EDX measurement using FlatQuad (manufactured by Bruker) was performed on each of the cathode active materials obtained in Examples 2 to 4, 6, and 7, and Comparative Example 2. The measurement voltage was set to 5 kV, and the current value/z coordinate was set to a value at which the maximum count value was 1850±100 cps when a 50 μm thick Al foil was qualitatively analyzed at a magnification of 1000 times. The resolution during mapping measurement was set to 640×480 pixels. Mapping measurement was performed with the measurement time of 8192 usec/pixels at a magnification of 1000 to 3000 particles per screen. After the measurement, the raw data (Nb,O) of the EDX measurement was converted to text in CSV format. First, grain boundary separation was performed using the mapping results of oxygen. After binarization using the minimum value between the two peaks visible in the histogram as the threshold, the overlap was separated by the watershed method. Particle analysis was executed on the obtained image to acquire the contour data of each particle. Using the contour data obtained from the oxygen mapping image, particle analysis was performed on each particle on the Nb mapping image to obtain the area (pixels) and average gray level of the particles. A histogram was created from the obtained results, with the average gray level on the abscissa and the number of pixels on the ordinate. The gray level was divided into steps with a width enough to keep the distribution within 20 divisions. The average value and standard deviation were obtained from the histogram, and the average value was the average film thickness and the standard deviation was the particle-to-particle bias, which was used as the evaluation index SED standard deviation for the uniformity of Nb. Table 3 shows the calculation results of the SED standard deviation for Example 1 and Comparative Example 1.

### Surface Composition Analysis

The surface composition of the lithium transition metal composite powders prepared in Examples 2 to 4, 6, and 7 and Comparative Example 2 was determined by procedures which follow.
(1) 0.20 g of lithium transition metal composite powder was precisely weighed out into a poly beaker.
(2) 10 mL of a buffer solution consisting of citric acid and trisodium citrate, having a pH of 5.8 and kept at 20° C. was added to the poly beaker.
(3) The buffer solution was stirred with a stirrer for 4 minutes while maintaining the temperature at 20° C. thereby obtaining an eluate in which the metal on the surface of the lithium transition metal composite powder was eluted.
(4) The eluate was filtered using a plastic syringe equipped with a syringe filter to obtain a filtrate.
(5) 0.5 mL of 6M HCl was added to 1 mL of the filtrate, and then the mixture was diluted with pure water to 50 mL to obtain a diluted solution.
(6) The diluted solution was subjected to ICP measurement to determine the surface composition of the lithium transition metal composite powder.

The cobalt ratio (Co/Me) was the mole ratio of cobalt to the total number of moles of metal components other than lithium; the nickel ratio (Ni/Me) was the mole ratio of nickel to the total number of moles of metal components other than lithium; and the manganese ratio (Mn/Me) was the mole ratio of manganese to the total number of moles of metal components other than lithium. The results are shown in Table 3.

TABLE 3

| | | | | SED |
|---|---|---|---|---|
| | | | | Standard |
| | Ni / Me | Co / Me | Mn / Me | deviation |
| Comparative | 0.73 | 0.09 | 0.18 | 5.3 |
| Example 2 | | | | |
| Example 2 | 0.41 | 0.40 | 0.19 | 2.4 |
| Example 3 | 0.45 | 0.27 | 0.28 | 2.9 |
| Example 4 | 0.53 | 0.17 | 0.29 | 3.1 |
| Example 6 | 0.38 | 0.29 | 0.33 | 2.7 |
| Example 7 | 0.32 | 0.38 | 0.30 | 2.5 |

In the surface composition of the lithium transition metal composite powder, the higher the Co/Me ratio, the lower the SED standard deviation, i.e., the more uniform the coating with the niobium compound was. This is thought to be because the Co coating reduced the amount of alkaline components due to excess lithium on the surface of the lithium transition metal composite powder, and the aggregation due to the alkaline components of the Nb compound is reduced.

### Solid Electrolyte

An argyrodite-type sulfide with an average particle diameter of 10 μm and a composition of Li_{5.4} PS_{4.4} Cl_{1.6} was used as a solid electrolyte.

A cathode composite was obtained by mixing 70 parts by mass of the cathode active materials obtained in Example 1 and Comparative Example 1, 27 parts by mass of the solid electrolyte, and 3 parts by mass of VGCF (registered trademark) which is vapor grown carbon fiber.

### Assembling Evaluation Battery

A cylindrical lower mold with an outer diameter of 11 mm was inserted into a cylindrical outer mold with an inner diameter of 11 mm from the bottom of the outer mold. The upper end of the lower mold was fixed to the outer mold at a position in the middle of the outer mold. In this state, 100 mg of solid electrolyte was fed from the top of the outer mold into the upper end of the lower mold. After feeding, a cylindrical upper mold with an outer diameter of 11 mm was inserted from the top of the outer mold. After inserting, a pressure of 50 MPa was applied from above the upper mold to mold the solid electrolyte to form a solid electrolyte layer. After molding, the upper mold was pulled out from the top of the outer mold, and 20 mg of the cathode composite was fed from the top of the outer mold onto the top of the solid electrolyte layer. After feeding, the upper mold was inserted again, and this time a pressure of 600 MPa was applied to mold the cathode composite to form a cathode active material layer. After molding, the upper mold was fixed; the lower mold was released from its fixing and pulled out from the bottom of the outer mold; and a negative-electrode active material LiAl alloy was fed from the bottom of the lower mold onto the bottom of the solid electrolyte layer. After feeding, the lower mold was inserted again, and a pressure of 50 MPa was applied from below the lower mold to mold the negative-electrode active material into a negative-electrode active material layer. The lower mold was fixed in place while the pressure was applied, and a positive electrode terminal was adhered to the upper mold and a negative electrode terminal was adhered to the lower mold to obtain an all-solid-state secondary battery for evaluation.

### D_{SEM} Measurement

D_{SEM} of the cathode active materials according to Example 1, Comparative Example 1, and Reference Examples 1 and 2 was obtained in accordance with the following procedure.
<1> A scanning electron microscope (Hitachi High-Technologies Corporation, SU8230) was used and the magnification was set so that the number of secondary particles whose particle contours could be confirmed was 10 to 20. Specifically, the acceleration voltage was 1.5 kV and the magnification was 4000 times. At this time, secondary particles with a particle diameter of less than half of D₁₀ were not included in the count.
<2> For all secondary particles whose particle diameters are more than half of D₁₀, as imaged by the above magnification, the contour length was obtained by tracing the contour of the primary particles that make up each of the secondary particles using image processing software (ImageJ). The sphere equivalent diameter was calculated from the contour length.
<3> The above processes <1> and <2> were repeated until the number of the primary particles with particle diameters calculated exceeded 100, and the average particle diameter D_{SEM} was calculated as the arithmetic mean value of the obtained spherical equivalent diameters. FIG. 4 shows the results of calculation including the ratio of D₅₀ to D_{SEM}.

TABLE 4

| | D_{SEM} | D₅₀ / D_{SEM} |
|---|---|---|
| | (μm) | — |
| Example 1 | 2.44 | 1.39 |
| Comparative | 2.55 | 1.42 |
| Example 1 | | |
| Reference | 2.44 | 1.15 |
| Example 1 | | |
| Reference | 2.69 | 1.49 |
| Example 2 | | |

The BET specific surface area of each cathode active material was measured by a gas adsorption method (one-point method) using nitrogen gas by use of a BET specific surface area measuring device (Macsorb, manufactured by Mountec Co., Ltd.). The results are shown in Table 5.

### Particle Size Evaluation

The physical property values of each cathode active material were measured as follows. A laser diffraction particle size distribution measuring device (SALD-3100, manufactured by Shimadzu Corporation) was used to measure the cumulative particle size distribution based on volume.

D₅₀ was determined as the particle diameter corresponding to 50% of the cumulative diameter from the small diameter side; D₁₀ was determined as the particle diameter corresponding to 10% of the cumulative diameter; D₉₀ was determined as the particle diameter corresponding to 90% of the cumulative diameter; and D₉₀/D₁₀ was calculated from the obtained values. The results are shown in Table 5.

### Tapped Density

The tapped density was measured using a tapping type powder reduction meter TPM-3P (Tsutsui Scientific Instruments). 20 g of each cathode active material was placed in a 20 mL measuring cylinder as a measurement container.

The number of shaking times was set to 150 times, and the volume density after shaking was obtained as the tapped density. The results are shown in Table 5.

### Measurement of Nickel Disorder and Crystallinity

X-ray diffraction spectrum (tube current 200 mA, tube voltage 45 kV) was measured by CuKα radiation for each cathode active material obtained in Example 1, Comparative Example 1, and Reference Example. In addition, the crystallinity was calculated by substituting into the Scherrer Formula the peak position and integral width due to the lattice plane (104) obtained from the measured X-ray diffraction spectrum. The disorder of the nickel element in the lithium transition metal composite oxide was determined by performing structural optimization by Rietveld analysis based on the obtained X-ray diffraction spectrum, with the composition model being (Li_{1-d}Ni_{d})(NiₓCo_{y}Mn_{z})O₂(x+y+z=1). The percentage of d of the composition model calculated as a result of the structural optimization was taken as the value of the disorder of the nickel element. The obtained results are shown in Table 5.

### Measurement of Nb Content

For the cathode active materials obtained in Example 1 and Comparative Example 1, the Nb content was measured using an inductively coupled plasma atomic emission spectrometer (ICP-AES; manufactured by PerkinElmer). The measured mass content percentages of Nb in the cathode active materials are shown in Table 5.

### Measurement of Unreacted Lithium in Cathode Active Material

Unreacted lithium in the cathode active materials obtained in Example 1, Comparative Example 1, and Reference Example was measured as follows. First, 10 g of each cathode active material was taken and placed in a container with a lid; 50 mL of pure water was added thereto; and the container was covered and stirred for 60 minutes. After standing, the supernatant liquid was filtered. The filtrate was titrated with a 0.025 mol/L sulfuric acid standard solution, wherein the inflection points near pH=8 and pH=4 were set as first and second end points, respectively. The content of LiOH and the content of Li₂CO₃ were calculated from the titration values of the first and second end points, based on the principle of the Warder method. The results obtained are shown in Table 5.

TABLE 5

| | | | | | | Tapped | | | Nb | LiOH | Li₂CO₃ |
|---|---|---|---|---|---|---|---|---|---|---|---|
| | D₁₀ | D₅₀ | D₉₀ | D₉₀ / D₁₀ | BET | density | Crystallinity | Ni_{dis} | content | content | content |
| | (μm) | (μm) | (μm) | — | (m²/g) | (g/cm³) | — | (%) | (wt %) | (wt %) | (wt %) |
| Example 1 | 2.11 | 3.38 | 5.97 | 2.83 | 1.43 | 2.30 | 636 | 1.8 | 0.92 | 0.23 | 0.15 |
| Comparative | 2.12 | 3.61 | 6.80 | 3.21 | 1.72 | 2.09 | 583 | 1.6 | 0.89 | 0.33 | 0.62 |
| Example 1 | | | | | | | | | | | |
| Reference | 1.76 | 2.77 | 4.35 | 2.47 | 0.86 | 1.94 | 578 | 1.6 | — | 0.53 | 0.41 |
| Example 1 | | | | | | | | | | | |
| Example 2 | 2.00 | 3.20 | 5.10 | 2.55 | 0.79 | — | 737 | 4.7 | 0.98 | 0.07 | 0.13 |
| Example 3 | 2.10 | 3.40 | 5.60 | 2.67 | 0.69 | — | 732 | 4.7 | 1.01 | 0.09 | 0.10 |
| Example 4 | 2.00 | 3.70 | 6.40 | 3.20 | 0.67 | — | 740 | 4.6 | 1.00 | 0.09 | 0.12 |
| Example 5 | 2.20 | 3.50 | 5.70 | 2.59 | 0.63 | — | 660 | 4.4 | 0.93 | 0.11 | 0.09 |
| Example 6 | 2.30 | 3.70 | 5.90 | 2.57 | 0.67 | 2.44 | 683 | 4.6 | 0.92 | 0.04 | 0.17 |
| Example 7 | 2.40 | 3.70 | 5.80 | 2.42 | 0.72 | 2.40 | 535 | 5.7 | 0.93 | 0.04 | 0.17 |
| Comparative | 2.20 | 3.30 | 5.26 | 2.39 | 0.62 | 2.12 | 810 | 2.5 | 0.99 | 0.14 | 0.33 |
| Example 2 | | | | | | | | | | | |

The LiOH and Li₂CO₃ contents in Example 1 are smaller than those in Comparative Example 1 and the Reference Example. This is considered to be due to the consumption of cobalt oxide by the reaction with excess lithium on the particle surface.

### SEM-EDX Line Analysis

After dispersing and solidifying the cathode active material obtained in Example 1 in epoxy resin, a cross-section polisher (manufactured by JEOL Ltd.) was used to make the cross-section of the secondary particles of the cathode active material to prepare a measurement sample. The measurement sample with the cross-section made was subjected to line analysis using a scanning electron microscope (SEM)/energy dispersive X-ray analysis (EDX) device (manufactured by Hitachi High-Technologies Corporation; accelerating voltage 3 kV) to perform composition analysis of the surface region and the internal region. The results of the composition analysis by line analysis are shown in FIG. 2, and the results of the concentration gradient of Co obtained from the analysis results are shown in Table 6.

TABLE 6

| | Depth of the | Depth of the | | | | | |
|---|---|---|---|---|---|---|---|
| | second region | first region | | | | | |
| | from the | from the | Co molar | Co molar | | Ni molar | Ni molar |
| | secondary | secondary | ratio | ratio | | ratio | ratio |
| | particle | particle | in the | in the | Co | in the | in the |
| | surface | surface | second | first | concentration | second | first |
| | (nm) | (nm) | region | region | gradient | region | region |
| Example 1 | 8 | 64 | 0.267 | 0.049 | 0.00389 | 0.511 | 0.677 |

### Impedance Measurement

The all-solid-state secondary battery for evaluation was charged and set to 50% state of charge (SOC). It was connected to an AC power source at 25° C. and subjected to resistance measurement by the AC impedance method. The frequency of the AC power source was logarithmically changed from 1 MHz to 0.1 Hz. Assuming an equivalent circuit, the diameter of the arc appearing in the frequency range of 1000 Hz to 5000 Hz inclusive was determined as the resistance derived from the cathode active material (resistance component in the impedance of the cathode/electrolyte interface) by fitting using the least squares method. The results are shown in Table 7.

### Charge/Discharge Evaluation

The prepared evaluation battery was charged and discharged at 2.2 V to 4.0 V inclusive using a charge/discharge tester (TOSCAT-3100, manufactured by Toyo Systems Co., Ltd.). The discharge current was applied at a current value when 0.1 C capacity was extracted, and after reaching the set voltage, the current was passed so as to keep the voltage constant. The charge/discharge was terminated when the current value reached the equivalent of 0.02 C. The obtained charge capacity, discharge capacity, and charge/discharge efficiency are shown in Table 7.

TABLE 7

| | Charge | Discharge | Charge / | |
|---|---|---|---|---|
| | capacity | capacity | discharge | Impedance |
| | (mAh/g) | (mAh/g) | efficiency | (Ω) |
| Example 1 | 247.9 | 207.7 | 83.78 | 32 |
| Comparative | 241.9 | 196.2 | 81.12 | 35 |
| Example 1 | | | | |

From the results of Table 7, the impedance of Example 1 was lower than that of Comparative Example 1. This is thought to be because the cathode active material according to Example 1 has a Co concentration gradient due to the second region, which improves the resistance. Example 1 is superior to Comparative Example 1 in charge capacity, discharge capacity, and charge/discharge efficiency, which is thought to be due to the reduction in overvoltage caused by the reduction in resistance.

The disclosures of Japanese Patent Application No. 2022-105831 (filing date: Jun. 30, 2022), Japanese Patent Application No. 2022-122790 (filing date: Aug. 1, 2022), and Japanese Patent Application No. 2023-097504 (filing date: Jun. 14, 2023) are incorporated herein by reference in its entirety. All documents, patent applications, and technical standards mentioned in this description are incorporated herein by reference to the same extent as if each individual document, patent application, and technical standard were specifically and individually described to be incorporated by reference.

What is claimed is:

1. A method for producing a cathode active material for a secondary battery, the method comprising:
providing a lithium transition metal composite powder in which a ratio of the number of moles of nickel atoms to the total number of moles of metal atoms other than lithium is 0.5 or more and less than 1 and a ratio of the number of moles of cobalt atoms to the total number of moles of metal atoms other than lithium is 0 or more and less than 0.5, the lithium transition metal composite powder having a layered structure;
contacting the lithium transition metal composite powder with a cobalt raw material to obtain a cobalt-adhered composite oxide;
subjecting the cobalt-adhered composite oxide to a first heat treatment performed at a temperature higher than 600° C. and lower than 800° C. to obtain a first heat-treated product;
contacting the first heat-treated product with a niobium raw material to obtain a niobium-adhered composite oxide; and
subjecting the niobium-adhered composite oxide to a second heat treatment performed at a temperature higher than 300° C. and lower than 500° C. to obtain a second heat-treated product.

2. The method for producing a cathode active material for a secondary battery according to claim 1, wherein
D₅₀/D_{SEM}, which is a ratio of a 50% particle diameter D₅₀ of a cumulative particle size distribution based on volume to an average particle diameter D_{SEM} based on observation with an electron microscope, of the lithium transition metal composite powder is 1 or more and 4 or less.

3. The method for producing a cathode active material for a secondary battery according to claim 1, wherein
in the lithium transition metal composite powder, a ratio of the number of moles of nickel atoms to the total number of moles of metal atoms other than lithium is 0.6 or more and less than 1.

4. The method for producing a cathode active material for a secondary battery according to claim 1, wherein
the obtaining the cobalt-adhered composite oxide comprises dry-mixing the lithium transition metal composite powder and the cobalt raw material.

5. The method for producing a cathode active material for a secondary battery according to claim 1, wherein
in the obtaining the cobalt-adhered composite oxide, the total molar amount of cobalt atoms contained in the cobalt raw material is 1 mol % or more and 20 mol % or less of the total molar amount of metal atoms other than lithium contained in the lithium transition metal composite powder.

6. The method for producing a cathode active material for a secondary battery according to claim 1, wherein
the cobalt raw material is cobalt oxide.

7. The method for producing a cathode active material for a secondary battery according to claim 1, wherein
the first heat treatment is performed at a temperature of 650° C. or higher and 750° C. or lower.

8. The method for producing a cathode active material for a secondary battery according to claim 1, wherein
in the obtaining the niobium-adhered composite oxide, the total molar amount of niobium atoms contained in the niobium raw material is 0.1 mol % or more and 5 mol % or less of the total molar amount of metal atoms other than lithium contained in the first heat-treated product.

9. The method for producing a cathode active material for a secondary battery according to claim 1, wherein
the second heat treatment is performed at a temperature of 350° C. or higher and 450° C. or lower.

10. The method for producing a cathode active material for a secondary battery according to claim 1, comprising:
contacting the first heat-treated product with a solution containing the niobium raw material to obtain the niobium-adhered composite oxide.

11. The method for producing a cathode active material for a secondary battery according to claim 1, wherein
the niobium raw material is niobic acid.

12. The method for producing a cathode active material for a secondary battery according to claim 1, wherein
in the lithium transition metal composite powder, a ratio of the number of moles of nickel atoms to the total number of moles of metal atoms other than lithium is 0.6 or more and less than 0.8.

13. The method for producing a cathode active material for a secondary battery according to claim 1, wherein
in a surface composition of the lithium transition metal composite powder determined by surface elution analysis, the ratio of the number of moles of cobalt atoms to the total number of moles of metal atoms other than lithium is 0.15 or more and 0.5 or less.

14. The method for producing a cathode active material for a secondary battery according to claim 1, wherein
the lithium transition metal composite powder has a composition represented by Formula (1) below: 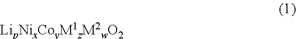
wherein in Formula (1), 0.95≤p≤1.5, 0.5≤x<1, 0≤y<0.5, 0≤z<0.5, 0≤w≤0.1, 0.8≤x+y+z+w≤1.2, M¹ includes at least one selected from the group consisting of Al and Mn, and M² includes at least one selected from the group consisting of B, Na, Mg, Si, P, S, K, Ca, Ti, V, Cr, Zn, Sr, Y, Zr, Nb, Mo, In, Sn, Ba, La, Ce, Nd, Sm, Eu, Gd, Ta, W, and Bi.

15. A cathode active material for a secondary battery, comprising:
a lithium transition metal composite oxide having a layered structure and having a composition in which the ratio of the number of moles of nickel atoms to the total number of moles of metal atoms other than lithium is 0.5 or more and less than 1 and in which the ratio of the number of moles of cobalt atoms to the total number of moles of metal atoms other than lithium is 0.01 or more and less than 0.5,
wherein the lithium transition metal composite oxide comprises a niobium compound on at least a part of a secondary particle surface, and
wherein the lithium transition metal composite oxide has a higher cobalt concentration in a second region approximately 10 nm deep from the secondary particle surface than in a first region approximately 60 nm deep from the secondary particle surface.

16. The cathode active material for a secondary battery according to claim 15, wherein
in the lithium transition metal composite oxide, the ratio of the number of moles of nickel atoms to the total number of moles of metal atoms other than lithium is 0.6 or more and less than 1.

17. The cathode active material for a secondary battery according to claim 15, wherein
D₅₀/D_{SEM}, which is a ratio of a 50% particle diameter D₅₀ of a cumulative particle size distribution based on volume to an average particle diameter D_{SEM} based on observation with an electron microscope, of the lithium transition metal composite oxide is 1 or more and 4 or less.

18. The cathode active material for a secondary battery according to claim 15, wherein
the absolute value of a value obtained by dividing a difference between the first and second regions in the ratio of the number of moles of cobalt atoms to the total number of moles of metal atoms other than lithium by a difference between the first and second regions in depth from their respective surfaces is 0.001 (nm⁻¹) or more and 0.08 (nm⁻¹) or less.

19. The cathode active material for a secondary battery according to claim 15, wherein
the ratio of the number of moles of nickel atoms to the total number of moles of metal atoms other than lithium in the lithium transition metal composite oxide is 0.6 or more and less than 0.8, and wherein
the secondary particle surface has an SED standard deviation that is 5.0 or less for niobium as determined by SEM-EDX measurement.

20. The cathode active material for a secondary battery according to claim 15, wherein
the lithium transition metal composite oxide has a composition represented by Formula (2) below: 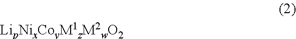
wherein, in Formula (2), 0.95≤p≤1.5, 0.5≤x<1, 0.01≤y<0.5, 0≤z<0.5, 0<w≤0.1, 0.8≤x+y+z+w≤1.2, M¹ includes at least one selected from the group consisting of Al and Mn, and M² includes at least one selected from the group consisting of B, Na, Mg, Si, P, S, K, Ca, Ti, V, Cr, Zn, Sr, Y, Zr, Nb, Mo, In, Sn, Ba, La, Ce, Nd, Sm, Eu, Gd, Ta, W, and Bi, and includes at least Nb.

21. A positive electrode for a secondary battery, comprising:
a cathode active material layer containing the cathode active material for a secondary battery according to claim 20.

22. A secondary battery comprising:
the positive electrode for a secondary battery according to claim 21;
a negative electrode; and
an electrolyte.
